(19) United States
(12) Patent Application Publication
(10) Pub. No.: US 2023/0242777 A1
(43) Pub. Date: Aug. 3, 2023

(54) CONDENSATION RESISTANT KETONE-BASED INKJET INKS

(71) Applicant: Videojet Technologies Inc., Wood Dale, IL (US)

(72) Inventors: Zheng Xue, Burr Ridge, IL (US); Michael Kozee, Wheaton, IL (US); Linfang Zhu, Woodridge, IL (US)

(21) Appl. No.: 17/590,235

(22) Filed: Feb. 1, 2022

(51) Int. Cl. C09D 11/033; C09D 11/102; C09D 11/328; C09D 11/38; C09D 11/52

(52) U.S. Cl. CPC C09D 11/033; C09D 11/38; C09D 11/52; C09D 11/102; C09D 11/328

(57) ABSTRACT

Embodiment of the present invention relate to a continuous inkjet ink composition which uses a higher order ketone solvent or solvents (ketones having 5 or more carbon atoms) in place or more hazardous solvents such as methyl ethyl ketone and a secondary solvent with a higher derived no effect inhalation level greater than 200 mg/m³ such as ethanol. These ink compositions contain a combination of resins including a cellulose resin and a polyurethane resin or an acrylic resin, with an optional third resin. A colorant (i.e., a dye, preferably a conductive dye) also is included.

### BACKGROUND

### 1. Field of the Invention

The invention relates to the field of inkjet printing and inks therefore. In particular, this disclosure describes inks and ink formulations that are resistant to moisture and condensation when printing while retaining excellent performance.

### 2. Background of the Invention

In general, an inkjet ink composition should meet certain requirements to be useful in inkjet printing operations. These relate to viscosity, resistivity, solubility, compatibility of components, and wettability of the substrate. Further, the ink should be quick-drying and smear-resistant, should be capable of passing through the inkjet nozzle without clogging, and should permit rapid cleanup of the machine components with minimum effort. In addition, the jet ink composition should provide printed images that are durable after printing particularly on nonporous substrates, which as is known to those of ordinary skill in the art, poses challenges with respect to achieving image adhesion on intended substrates.

In general, an inkjet ink composition should meet certain requirements to be useful in inkjet printing operations. These relate to viscosity, resistivity, solubility, compatibility of components, and wettability of the substrate. Further, the ink should be quick-drying and smear-resistant, should be capable of passing through the inkjet nozzle without clogging, and should permit rapid cleanup of the machine components with minimum effort. In addition, the jet ink composition should provide printed images that adhere well to the substrates, particularly nonporous substrates, which, as is known to those of ordinary skill in the art pose challenges with respect to achieving image adhesion.

Continuous inkjet ink compositions are generally formulated to include one or more solvents, one or more colorants and one or more binder resins. Inkjet compositions also can include one or more surfactants, plasticizers, adhesion promoters, conductive agents, defoamers, and mixtures thereof. While CIJ ink compositions are manufactured to be safe when produced and used according to regulatory requirements, concerns remain about the use of certain chemicals in these inks, particularly solvents. Safety and regulatory requirements of CIJ inks are becoming more stringent. Industrial customers in a given country or region are often increasingly constrained by what kind of chemicals they may import into and use within their factories. CIJ printings using organic solvents may also be regulated at the factory level by VOC (volatile organic compound) emissions guidelines or limitations to manners in which hazardous wastes are disposed. Depending on local restrictions it may also be more difficult to recycle packaging materials that have been in contact with inks.

Therefore, for plant operators there may be real present or even future potential concerns regarding the safety or sustainability of their CIJ inks and packaging in contact with said inks. Methyl ethyl ketone (MEK), which is the most widely used industrial CIJ solvent, is under increasing regulatory scrutiny due to its Environmental Health and Safety concerns. For example, MEK is on Japan’s list for Ordinance on Prevention of Organic Solvents Poisoning under the Japanese Industrial Safety and Health Law. Very recently the European Chemicals Agency has required MEK to be tested for reproductive toxicity with results pending. In addition, MEK is a drug precursor and is regulated by the US DEA as well as many other countries around the world, making importing and exporting MEK fluids challenging and costly. As such MEK imposes a potentially high future regulatory risk to inkjet customers.

Ketones such as MEK have been so widely adopted because they are fundamentally good solvents for CIJ inks. As an alternative, acetone has also been commonly used, but to a limit because acetone-based inks are prone to lose excessive amounts of solvent during storage and more during operation when the CIJ system temperatures can approach the boiling point of pure acetone. During jetted stream recovery in the CIJ ink system, air blends with the ink and the resulting volatilized solvents may be lost to the local environment by ventilation from the ink system. CIJ printers routinely employ a makeup fluid comprising the same solvent or a blend that includes each of the volatile solvents within the ink to replace solvents lost from the ink due to evaporative loss. However, evaporative loss of acetone can be so high under certain conditions that it can be challenging from a system engineering perspective to replenish makeup quickly enough and to maintain stable internal system pressures and jet stability. In practice, it is also thus tedious for operators to constantly replenish makeup. The environmental burden is also higher as a result due to high level of makeup fluid consumption.

Because CIJ technology is the dominant technology for marking and coding of products in industrial settings in all regions worldwide, often these production operations occur in non-climate controlled environments. Therefore, CIJ printers need to work across a very broad temperature and humidity range. While current CIJ systems serve well in most applications, usage models are continually expanding. At or near environmental extremes inkjet printers can become more unreliable or the cost of operation can increase, for example, since volatile solvents used in the inks can be consumed at greater rates.

Therefore, there is a need in the art for continuous inkjet ink compositions that meet the necessary requirements for reliable printing, environmental health and safety and use, and that have lower costs for makeup solvents during use.

### SUMMARY OF THE INVENTION

Therefore, the invention here provided, in certain embodiments, CIJ ink compositions that use high order ketone (HOK) solvents rather than traditional MEK-based solvents that are deemed hazardous due to toxicity, strong odor, or other undesirable characteristics. In particular, embodiments of the invention include a continuous inkjet ink composition comprising a primary ketone solvent which contains at least 5 carbon atoms; at least one secondary solvent with a derived no effect inhalation level greater than 200 mg/m³; a first cellulose resin; a second polyurethane resin; optionally, a third resin; and a colorant.

In other embodiments, the invention relates to a continuous inkjet ink composition comprising: a solvent system consisting essentially of a primary ketone solvent which contains at least 5 carbon atoms and at least one secondary solvent selected from the group consisting of acetone, methanol, ethanol, n-propanol, isopropanol, or a combination thereof; a first cellulose resin; a second polyurethane resin; optionally, a third resin; and a colorant.

In certain preferred embodiments, the continuous inkjet ink composition comprises MPK as the primary ketone solvent and ethanol as the secondary solvent, wherein the ratio of MPK to ethanol is from about 2.5:1 to about 15:1. Embodiments of the invention also relate to continuous inkjet ink compositions as described above wherein the primary ketone solvent comprises at least about 40% to about 80% by weight of the ink composition. In addition, in some embodiments, the secondary solvent comprises up to about 50% by weight of the ink composition, or about 20% or less by weight of the ink composition.

In preferred embodiments of the invention, the secondary solvent is selected from the group consisting of ethanol, n-propanol, isopropanol, or a combination thereof.

In preferred embodiments, the continuous inkjet ink composition contains less than 5% by weight of the ink composition of water.

The cellulose resin in some embodiments of the invention is a cellulose ester resin.

In embodiments containing a third resin, this resin preferably is selected from the group consisting of an acrylic resin, a rosin ester, a terpene phenolic resin, a silicone resin, a tosylamide resin, and a combination thereof.

In some embodiments, the ratio of polyurethane resin to other resins combined is 1:4 or greater.

In some embodiments, colorant is a conductive dye. In some embodiments, the continuous inkjet ink composition is substantially free of conductive agent that is not a conductive dye.

Certain embodiments of the invention comprise at least 100 ppm of a silane-based adhesion promotor. Certain embodiments of the invention comprise a surfactant or wetting agent. Certain embodiments of the invention comprise a defoamer.

In some embodiments of the invention, the continuous inkjet ink composition contains total ink solids of about 15% and about 30%, or of about 8% to about 20%.

Preferably, the continuous inkjet ink composition of claim 1 has a dry time for printed codes of less than about 5 seconds at 20° C. to 25° C. Preferably, the continuous inkjet ink composition has an initial ink resistivity of 1600 ohms cm or lower at 25° C.

A preferred embodiment of this invention relates to a continuous inkjet ink composition of claim 1 comprising: about 60% methyl propyl ketone solvent; about 15% ethanol; less than about 2% water; about 6.5% cellulose ester resin; about 5% polyurethane resin; about 9% dye; about 1.2% silane adhesion promoter; and about 0.1% surfactant.

### BRIEF DESCRIPTION OF THE FIGURES

FIG. 1 is a table showing results for printer evaluation tests of CIJ ink compositions.

FIG. 2 is a table showing results for makeup compositions in CIJ printer tests.

### DETAILED DESCRIPTION

### 1. Definitions

Unless defined otherwise, all technical and scientific terms used herein have the same meaning as commonly understood by one of ordinary skill in the art. Although various methods and materials similar or equivalent to those described herein can be used in the practice or testing of the present invention, suitable methods and materials are described below. However, the skilled artisan understands that the methods and materials used and described are examples and may not be the only ones suitable for use in the invention. Moreover, as measurements are subject to inherent variability, any temperature, weight, volume, time interval, pH, salinity, molarity or molality, range, concentration and any other measurements, quantities or numerical expressions given herein are intended to be approximate and not exact or critical figures unless expressly stated to the contrary.

As used herein, the term “about,” as used herein, means plus or minus 20 percent of the recited value, so that, for example, “about 0.125” means 0.125 ±0.025, and “about 1.0” means 1.0 ±0.2.

As used herein, the term “derived no-effect level (DNEL)” refers to the level of exposure to a substance above which humans should not be exposed or does not harm human health.

As used herein, the term “high order ketone (HOK)” refers to an organic ketone solvent containing at least 5 carbon atoms, preferably 5 or 6 carbon atoms.

### 2. Overview and Summary of Results

Embodiments of the CIJ ink compositions according to this invention use the combination of a higher order ketone solvent, a secondary solvent, a colorant, a cellulose resin, a polyurethane resin and optionally a third co-resin. The inks (1) can use dye as the main conductive species rather than employing dye salt combinations which have precarious stability; (2) can contain acetone to improve dry time; and (3) can use a combination of HOK and ethanol solvents to provide the advantages of HOK solvents with respect to adhesion while minimizing the cost of makeup and makeup consumption, preferably up to about 80% HOK.

### 3. Embodiments of the Invention

### A. Introduction

The preferred ink compositions of this invention comprise a primary HOK solvent, a secondary solvent preferably with a DNEL greater than 200 mg/m³, a first cellulose resin, a second polyurethane resin, optionally a third resin, and a colorant. These components provide inks that avoid the use of MEK as a solvent and also meet all the requirements of a CIJ ink, and have a reduced need for makeup solvents.

It has been found that using higher order ketones (HOKs) to replace lower order ketones can be used to formulate new inks. HOKs are good solvents for desired ink ingredients including resins, conductive dyes and certain conductive salts. HOKs are also relatively hydrophobic and unlikely to pick up excessive environmental water. HOKs also provide good adhesion because they tend to help CIJ coding inks to penetrate some common plastics.

However, several factors are encountered developmentally when employing ketones with more than 4 carbons such as MPK or MIPK. As compared with lower ketones (≤ 4 carbons), HOKs are less conductive, slower drying after printing, contribute to the insolubility of inorganic impurities, and can be highly aggressive toward plastics or rubber used within the printing ink system. The increased cost of HOKs particularly in the makeup compositions can also limit their usefulness.

The current invention can be used for both inks and complimentary makeup compositions that enable the use of HOKs in inks that exhibit a favorable combination of good solvency, high enough volatility, printer compatibility, cost, user friendliness and adhesion particularly to water-drenched or condensing glass surfaces. The preferred makeup solvent compositions of this invention comprise a primary HOK solvent and a secondary solvent preferably with a DNEL greater than 200 mg/m³, and optionally one or more additional solvents.

The inks and makeups presented here enable the performance of non-MEK inks across the full operational spectrum expected of CIJ coding printers. For example, when operated at higher temperature, the inks are inherently more conductive as it is observed that a CIJ ink’s electrical resistance generally drops as a function of increasing temperature. However, as the temperature drops, the conductivity sometimes falls below an acceptable threshold for printer operation. However, the inventive inks display an ink conductivity that is above the critical threshold across all relevant environments ranging from about 0° C. to 50° C. for proper CIJ operation. The invention also has the advantage in that these solvents are less volatile than MEK and that makeup consumption can be 50% less or even 70% less than that of an equivalent MEK-based ink depending on operating temperature. These features produce improvements in all aspects cited above: e.g., reduced volatile organic compounds (VOCs) emission, environmental waste by reducing plastic container disposal, reduced operator time spent maintaining the printer, better sustainability, etc.

### B. Solvents

Higher order ketones (HOK) such as methyl n-propyl ketone, diethyl ketone, and methyl isopropyl ketone are not drug precursors and are not on the Japanese list of Class II solvents. In addition, higher order ketones are relatively hydrophobic compared to alcohols and lower order ketones, so less water will be absorbed by the ink in the printer in humid environments, potentially leading to better ink stability during operation and hence better printer performance. It has been found here that the HOK-based ink compositions of the invention surprisingly have these beneficial properties while operating well as CIJ inks.

The solvent mixtures useful in the inventive embodiments here include a primary solvent which is one or more HOK. HOK solvents include any ketone solvent having 5 or more carbon atoms. More preferred HOK solvents have 5 or 6 carbon atoms, such as methyl propyl ketone (MPK); methyl isopropyl ketone (MIPK); diethyl ketone (DEK); methyl isobutyl ketone (MIBK); methyl n-butyl ketone, (MBK) cyclohexanone (CH), ethyl propyl ketone (EPK), methyl cyclopentanone (MCP) and a combination thereof. MPK and MIPK are highly preferred solvents, and MPK is the most preferred solvent. Therefore, the primary solvent can contain any single one of or any combination of these HOK solvents, but preferably is MPK or MIPK.

Compositions according to embodiments of the invention preferably contain at least about 40% primary solvent by weight, or about 35% to about 90% primary solvent by weight of the total ink composition. For example, the ink compositions can contain at least about 45% by weight of the primary solvent, about 50% by weight of the primary solvent, about 60% by weight of the primary solvent, about 70% by weight of the primary solvent, or about 80% by weight of the primary solvent. Most preferably, the ink compositions contain between about 55 and 75% of the primary solvent by weight of the total ink composition.

Solvent(s) used with the ink compositions preferably have the highest possible odor threshold and lowest inhalation risk. Table 1 below compares the odor thresholds of different ketones and alcohol solvents, lists those on Japan’s Ordinance on Prevention of Organic Solvent Poisoning which aims to ensure industrial health and safety of workers engaged in printing operations, and lists the derived no-effect levels (DNEL). HOK type solvents tend to exhibit lower odor thresholds than that of MEK and lower DNEL values.

TABLE 1

Solvent Characteristics

| Common Name | Odor Threshold (ppm)* | Japan ISHA Class II Solvent* | DNEL inhalation (mg/m3)** |
|---|---|---|---|
| Acetone | 62 | YES | 1210 |
| Ethanol | 100 | NO | 950 |
| DEK | 2.8 | NO | 708 |
| MEK | 10 | YES | 600 |
| Isopropanol | 35 | YES | 500 |
| Methyl n-amyl ketone (MnAK) | <1 | NO | 394 |
| n-butanol | 11 | YES | 310 |
| n-propanol | 11 | NO | 268 |
| MIPK | <1 | NO | 265 |
| MPK | 13 | NO | 209 |
| MIBK | 4 | NO | 83 |

*Please note the odor threshold data in the table is gathered through various sources. Due to the subjective nature of the test, odor threshold can vary depending on the source of data. **The DNEL data is extracted from the REACH registration database.

Furthermore, alcohols in general have odor thresholds higher than MEK. Ethanol and isopropanol also tend to have higher DNEL values which is the level of exposure to a substance above which humans should not be routinely exposed. A solvent may be safer overall if the volatility of that solvent is low enough to reduce the overall exposure to a safer level. For example, MPK has an evaporation rate roughly 50% that of MEK. Therefore the net exposure of an operator to MPK solvent would be about 50% that of MEK per unit time. In addition, a solvent blend may be rendered safer by blending with a solvent with a higher DNEL level, and therefore it is advantageous to blend HOK with solvents such as ethanol or isopropanol to potentially reduce the overall risk of exceeding exposure limits.

Based on the above, a preferred combination of solvent is MPK with an alcohol to minimize net odor and improve net exposure limits. A particularly preferred combination is MPK and ethanol, the latter of which exhibits a very high relative DNEL-inhalation limit.

Acetone, though exhibiting a high relative DNEL level, evaporates very quickly during CIJ operation and its use can result in high cost and inconvenience in terms of makeup. Acetone is also a regulated solvent in many countries. Thus, acetone can be considered not preferred for use in inkjet printing, particularly in higher concentrations. Lower order alcohols such as ethanol, isopropanol and n-propanol, though generally suitable for use in the makeup solution due to their hygroscopic nature, can lead to higher printed dry times as compared with ketones of similar molecular weight. Thus, alcohols also can be considered nonpreferred solvents by those of skill in the art. However, it has been found surprisingly that ethanol and/or n-propanol do not absorb enough water to significantly detract from the printed code’s dry time when combined up to certain levels with selected higher order ketones.

The ink compositions thus also contain a secondary solvent or mixture of solvents. This secondary solvent or mixture of solvents preferably has a derived no effect inhalation level greater than 200 mg/m³. The secondary solvent or solvent mixture preferably contains ethanol, n-propanol, isopropanol, or a combination thereof.

In certain embodiments, the solvent mixture or solvent system is free of or substantially free of acetal solvents such as ethylal and methylal. In other embodiments according to the invention, the ink compositions contain a solvent mixture or solvent system that consists essentially of a primary ketone solvent which contains at least 5 carbon atoms and at least one secondary solvent selected from the group consisting of acetone, methanol, ethanol, n-propanol, isopropanol, or a combination thereof.

Compositions according to embodiments of the invention preferably contain about 0.25% to about 50% of the secondary solvent by weight of the total ink composition. For example, the ink composition can contain about 0.5% to about 40% of the secondary solvent by weight, or about 1% to about 30% of the secondary solvent by weight, or less than about 20% of the secondary solvent by weight, or less than about 10% of the secondary solvent by weight.

Preferred continuous inkjet ink composition according to embodiments of the invention also contain less than 5% water by weight of the ink composition, preferably less than 4% or 3% or 2% or 1% water by weight of the ink composition. In some embodiments, ink compositions according to embodiments of the invention contain substantially no water, i.e., no added water or no detectable water.

### C. Resins

Inks according to embodiments of the invention generally combine a higher order ketone with one or more resins. Preferably, the primary resins include cellulose resins and polyurethane resins. Preferably, the ink compositions contain a mixture of a cellulose resin and a polyurethane resin, or a mixture of these with a third resin such as an acrylic resin, a silicon resin, or a rosin ester. These combinations of resins have been found to impart good adhesion to the ink compositions made with an HOK solvent base. The resin or combination of resins discussed above can be used with an optional third resin.

Cellulose resins are preferably cellulose ester resins, but may include, for example, cellulose acetate, cellulose acetate butyrate, and cellulose acetate propionate, or a mixture thereof. Preferred cellulose ester resins are cellulose acetate butyrate or cellulose acetate propionate with a Tg greater than 70° C. or more preferably greater than 90° C. Most preferred cellulose ester resins exhibit molecular weights below 100k Daltons and are readily resoluble in MPK, such as CAB 551-0.01.

Acrylic resins can be homopolymers or incorporate two or more monomers with or without specific functional groups. Functionalized acrylic resins can be derived from an alkyl-type monomer such as a methacrylate plus a functionalized monomer with such functionality as acrylic acid or methacrylic acid or other functional monomers such as amino modified acrylates or hydroxyl modified acrylates.

Examples of acrylic resins also include styrene-acrylic resins which can be made by copolymerizing styrene with acrylic monomers such as acrylic acid or methacryl acid, and optionally with alkyl acrylate monomers such as methyl acrylate, methyl methacrylate, butyl acrylate, butyl methacrylate, hydroxyethyl acrylate, hydroxyethyl methacrylate, and the like made by BASF™. under the trade name JONCRYL™. Examples of JONCRYL™ resins include JONCRYL™ 555, 586, 678, 680, 682, 683, and 67. Examples of suitable resins are those from Dow Chemical Corporation™ sold under the trade-name Acryloid™ or Paraloid™ or Dianal™ resins from Dianal Corporation™. A specific example of a non-functionalized resin is sold under the name B-66 which is a methylmethacrylate and butylmethacrylate copolymer with a molecular weight of approximately 50,000 Daltons or B-99n which is a similar copolymer with a molecular weight below 30,000 Daltons. A specific example of a preferred functionalized acrylic resin is Dianal PB-204™. A specific styrenated acrylic resin is JONCRYL™ 611 which exhibits an acid number less than 100. Other suitable acrylics are acrylic polyols with high hydroxyl value such as JONCRYL™ 587.

Polyurethane resins can be the reaction products of polyols and diisocyanates. Examples of polyols include ethylene glycol, propylene glycol, propanediol, butanediol, polyethylene glycol, polypropylene glycol, polyethylene glycol adipate diol, polyethylene glycol succinate diol, polytetrahydrofuran diol, and the like. Examples of diisocyanates include 2,4-tolylene diisocyanate, 2,6-tolylene diisocyanate, 4,4,-diphenylmethane diisocyanate, hexamethylene diisocyanate, and the like. Polyurethane resins with a molecular weight in the range of about 3,000 to about 50,000 are preferred. Polyurethane resins with a molecular weight in the range of about 3,000 to about 20,000 are most preferred. Examples of polyurethane resins include Reze-Lastic™ 2133, Reze-Lastic™ 2140, and Reze-Lastic™ 2155 from US Polymers-Accurez.

Resins that can be used as an optional third resin include an acrylic resin, a rosin ester resin, a terpene phenolic resin, a silicone resin, a tosylamide resin, and a combination thereof. Most preferably, the third resin is a silicone comprising repeating siloxane units. Each siloxane maybe a random mixture of diphenyl, methyl phenyl or dimethyl siloxane. Said siloxane resin exhibits a molecular weight between about 500 and 6000 Daltons, is a solid at room temperature and is functionalized at the terminal positions with hydroxyl groups.

Preferably, the resin compounds comprise about 5% to about 30% by weight of the ink composition, more preferably about 8% to about 20% % by weight of the composition, and most preferably about 10% to about 16% by weight of the composition. In some embodiments, the preferred resin combination includes a urethane resin and at least one other resin to ensure a combination of good water resistance and ink hardness after drying. In other embodiments, the urethane resin is combined in a ratio of at least about 1:4 (0.25) polyurethane to other resins combined or at least about 1:3 (0.33) and no more than 1:1 (1). Most preferably the ratio ranges between about 0.3 to 0.8 and even more preferably from about 0.3 to 0.7.

In yet other embodiments, the third resin is incorporated at a level between about 1 and 7% or more preferably between about 2 and 6% by weight of the composition.

### D. Colorants

Inks that contain safer solvent black dyes are also generally being required by CIJ inkjet ink customers. One component that has historically been safe to use is CI Index Solvent Black 29, however Solvent black 29 has increasingly been categorized by GHS classifications as a reproductive toxin. Alternative dyes include another Solvent Black dye such as Solvent Black 27. These dyes are colorants in the inks, but also serve as conductive agents in CIJ inks, which render the ink conductive enough to charge and deflect properly in order to produce the printed image. However, Solvent Black dyes, particularly Solvent Black 27, can be unstable during operation and even more unstable when paired with nucleophilic species such as conductive salts. It is imperative for inks where dyes are employed as the conductive agents that these dyes are also stable in the storage bottle and while running in the printer.

### E. Summary

The current invention employs an ink with HOKs and optionally one or more cosolvents such as acetone and/or alcohol. The surprisingly simple combination yields inks that have properties that lend to good jetting which can further be maintained over a broad range of operational environments. The inks using these combinations achieve high durability in harsh environments, for example after being soaked for extended periods in water or subject to prolonged surface condensation as is the case for printing on cold food and cold-filled beverage packaged goods. The inks described here are able to penetrate a thin layer of condensation on cold-filled bottles and provides good adhesion with condensation resistance. While not wishing to be bound by any theories, this performance is at least in part due to achieving sufficient ink conductivity with a combination of relatively high ink resin solids and dye solids, without the need for a specific conductive agent which tends to interfere with ink adhesion on wet surfaces, in addition to the unique combination of resins, dyes and adhesion promotors.

Inkjet compositions also can include one or more surfactants, plasticizers, adhesion promoters, conductive agents, defoamers, and mixtures thereof. In general, when surfactants and defoamers are employed, the combined total of these compounds should be less than about 0.5% and preferably less than about 0.1 % of the composition.

Adhesion promotors are reactive silanes comprising ethoxy or methoxy leaving groups. A preferred example is Silane A-187 (3-glycidyl-oxypropyl-trimethoxysilane0. Silanes should be incorporated at a minimum level of 100 ppm, or more preferably 1000 ppm or even more preferably from about 0.1 to about 1.5 weight percentage.

### 5. EXAMPLES

This invention is not limited to the particular processes, compositions, or methodologies described, as these may vary. The terminology used in the description is for the purpose of describing the particular versions or embodiments only, and is not intended to limit the scope of the present invention which will be limited only by the appended claims. Although any methods and materials similar or equivalent to those described herein can be used in the practice or testing of embodiments of the present invention, the preferred methods, devices, and materials are now described. All publications mentioned herein, are incorporated by reference in their entirety; nothing herein is to be construed as an admission that the invention is not entitled to antedate such disclosure by virtue of prior invention.

### Example 1: Matching MEK Conductivity and Glass Adhesion

Several formulations of CIJ inks the present invention were made in order to compare their properties and adhesion with a prior art methyl ethyl ketone (MEK) ink, here referred to as Comparative Example 1 (CE1). This ink is a market leader for printing on products that are cold or that might be exposed to moisture during their life. CE1 exhibits acceptable dry time after printing and adhesion to a variety of materials including glass, polyester and low density polyethylene plastic materials. The inks were tested by printing codes with a Videojet CIJ printer affixed with a 60 micron nozzle. Printed codes were evaluated for average dry time and adhesion to cold/condensing glass. The ink components and testing results are summarized in Tables 2 and 3, below. IE refers to inventive examples.

Viscosity was measured at 25° C. on a Brookfield DV1 Digital Viscometer (Model# DV1MLVTJ0). Resistivity was measured at 25° C. on an Orion Star™ A212 Conductivity Benchtop Meter. Wet adhesion testing was performed as follows: the substrates of interest (glass microscope slide or unopened non-returnable beer bottles) were refrigerated to approximated 5° C. prior to printing. Codes were printed onto the substrates immediately (<1 second) after the printed area was briefly dried with an air knife. The coded substrates were then aged in an environmentally controlled cabinet (at 30° C./50% R.H.) for about 4 hours followed by soaking in an ice water bath overnight. While the substrates were still wet, the printed codes were rubbed with medium pressure using a wet thumb 10 times. Results for wet adhesion are reported as Excellent, Good, Acceptable, or Poor.

TABLE 2

Ink Composition Examples (% components)

| Example Component | CE1 | CE2 | CE3 | IE1 | IE2 | IE3 | IE4 | IE5 |
|---|---|---|---|---|---|---|---|---|
| (% by weight) | | | | | | | | |
| MEK (solvent) | 61.2 | | 53.0 | | | | | |
| MPK (solvent) | | | | 70.7 | 60.4 | | 44.9 | 71.6 |
| MIPK (solvent) | | 53.0 | | | | 44.9 | | |
| Acetone (solvent) | | 15.0 | 15.0 | 6.0 | 6.0 | 15.0 | 15.0 | |
| Ethanol (solvent) | 2.1 | | | | | | | |
| n-Propanol (solvent) | | | | | 6.0 | 15.0 | 15.0 | 3.0 |
| Water (solvent) | | 1.0 | 1.0 | 1.0 | 1.0 | 1.0 | 1.0 | 1.0 |
| J611 (acrylic resin) | 15.5 | 10.0 | 10.0 | | 6.7 | | | 3.3 |
| B66 (acrylic resin) | | | | | | 4.8 | 4.8 | |
| Rezlastic™ 2123 (polyurethane resin)* | 8.3 | 6.0 | 6.0 | 5.2 | 5.1 | 4.8 | 4.8 | 5.2 |
| Xiameter™ RSN-0233 (silicon resin) | 3.1 | 2.0 | 2.0 | | | 1.6 | 1.6 | |
| CAB 551-0.01 (cellulose ester resin) | | 3.0 | 3.0 | 6.6 | 4.2 | 2.4 | 2.4 | 5.3 |
| Valfast™ 3840 (dye) | 8.3 | 9.0 | 9.0 | 9.0 | 9.0 | 9.0 | 9.0 | 9.0 |
| PDMS 100 (defoamer) | | 1.0 | 1.0 | | 0.1 | | | 0.1 |
| Silane A187 (adhesion promoter) | 1.5 | | | 1.5 | 1.5 | 1.5 | 1.5 | 1.5 |
| Total | 100.0 | 100.0 | 100.0 | 100.0 | 100.0 | 100.0 | 100.0 | 100.0 |
| Solids | 34.6 | 29.5 | 29.5 | 21.0 | 25.3 | 22.9 | 22.9 | 23.1 |

* Rezlastic™ is a polyurethane resin at approximately 75% solids in a blend of ethyl acetate and ethanol.

TABLE 3

Ink Composition Testing Results

| | | | | | | | | |
|---|---|---|---|---|---|---|---|---|
| Test | CE1 | CE2 | CE3 | IE1 | IE2 | IE3 | IE4 | IE5 |
| Initial viscosity (cP) | 3.8 | 4.1 | 3.9 | 3.3 | 4 | 3.8 | 3.9 | 3.8 |
| Initial resistivity (Ohm-cm) | 1370 | 1796 | 1301 | 1217 | 1523 | 1380 | 1293 | 1386 |
| Wet adhesion (glass slide) | Good | Poor | Poor | Excel | Good | Excel | Good | Excel |
| Wet adhesion (bottle) | Good | Accep | Accep | Accep | Good | Accep | Accep | Good |

Accep = acceptable.

As is seen by Inventive Examples 1 to 5, above, it is possible to formulate an HOK-based ink with resistivity lower than 1600 ohms-cm and as good or better than inks using MEK and at similar ink viscosities by reducing overall solids and including a co-solvent in the formulation. In general, inks with about 29% or lower total solids and less than about 20% resin solids provided acceptable solution conductivities and wet glass adhesion.

### Example 2 Additional Ink Composition Examples

Additional compositions were produced to examine performance of their printed codes. The testing included viscosity, resistivity, printed code dry time, wet adhesion, pasteurization resistance, abrasion resistance, and tape transfer resistance. The ink compositions are described in Table 4 and test results are provided in Table 5. The inks were tested by printing codes with a Videojet CIJ printer affixed with a 60 micron nozzle.

Method for testing viscosity, resistivity, and wet adhesion are described above. Dry time was defined as the time required for an ink code to dry to tack-free after being printed on the substrate, and was measured by printing a 7-high code onto the target substrate with printed dots not overlapping and recording the time between printing the code and the point where no smearing of the code was observed when gently rubbed. Since dry time is highly dependent on the nature of substrate, it was assessed separately on aqueous coated paper, glass, PVC, and polyester, and averaged to obtain the result presented in Table 5. Pasteurization resistance testing was performed by submerging coded substrates in a 165° F. water bath for 30 minutes, followed by thumb rubbing the codes with medium pressure for 5 times. Abrasion resistance testing was performed by scuffing the printed codes back and forth for 10 times with a piece of virgin kraft paper (uncoated and unwaxed) weighted down against the code with a vertically affixed 3 kg load. Tape transfer resistance testing was performed by applying a piece of 3 M Scotch Transparent Tape #600 (or equivalent) over the entire printed code using one firm (2-3 kg) rub. The tape was removed rapidly at a ca. 180° angle and then the percentage of code transferred to the tape was examined. Results for wet adhesion, pasteurization resistance, Kraft abrasion resistance, and tape transfer resistance are reported as Excellent, Good, Acceptable, or Poor.

TABLE 4

Additional Ink Composition Examples (% components)

| Example Component (%) | CE1 | IE8 | IE9 | IE10 | IE11 | IE12 | IE13 | IE14 |
|---|---|---|---|---|---|---|---|---|
| MPK (solvent) | See above | 71.7 | 73.0 | 60.9 | 63.0 | 58.6 | 58.6 | 58.6 |
| n-Propanol (solvent) | | 3.0 | 3.0 | | | | | |
| SDA3C (ethanol solvent) | | | | 15.0 | 15.0 | 15.0 | 15.0 | 15.0 |
| Water (solvent) | | 1.0 | 1.0 | 1.0 | 1.0 | 1.0 | 1.0 | 1.0 |
| Rezlastic™ 2123 (polyurethane resin) | | 6.9 | 4.9 | 5.0 | 2.0 | 5.0 | 5.0 | 5.0 |
| U115 (terpene phenolic resin) | | | | | | 3.0 | | |
| Stabelite (Coresin resin) | | | | | | | 3.0 | |
| Ad Pro MTS (tosylamide resin) | | | | | | | | 3.0 |
| CAB 551-0.01 (cellulose ester resin) | | 6.8 | 7.5 | 7.5 | 8.4 | 6.8 | 6.8 | 6.8 |
| Valfast™ 3840 (dye) | | 9.0 | 9.0 | 9.0 | 9.0 | 9.0 | 9.0 | 9.0 |
| PDMS 100 (defoamer) | | 0.1 | | | | | | |
| DC205 (surfactant) | | | 0..1 | 0.1 | 0.1 | 0.1 | 0.1 | 0.1 |
| Silane A187 (adhesion promoter) | | 1.5 | 1.5 | 1.5 | 1.5 | 1.5 | 1.5 | 1.5 |
| Total | | 100.00 | 100.00 | 100.00 | 100.00 | 100.00 | 100.00 | 100.00 |
| Solids | 34.6 | 22.5 | 21.7 | 21.8 | 20.5 | 24.1 | 24.1 | 24.1 |

TABLE 5

Ink Composition Testing Results

| | | | | | | | | |
|---|---|---|---|---|---|---|---|---|
| Test | CE1 | IE8 | IE9 | IE10 | IE11 | IE12 | IE13 | IE14 |
| Initial viscosity (cP) | 3.8 | 4.2 | 4.0 | 4.0 | 4.2 | 4.2 | 4.8 | 5.0 |
| Initial resistivity (Ohm-cm) | 1370 | 1409 | 1480 | 1410 | 1334 | 1511 | 1485 | 1516 |
| Dry Time (seconds at 20-25° C.) | 1.6 | 3.0 | 2.3 | 2.0 | 2.0 | 2.5 | 2.1 | 2.3 |
| Wet adhesion (glass slide) | Good | Good | Excel | Excel | Good | Excel | Excel | Excel |
| Wet adhesion (bottle) | Good | Good | Good | Excel | Poor | Excel | Excel | Excel |
| Pasteurization resistance | Accep | Accep | Accep | Accep | Poor | Accep | Accep | Accep |
| Kraft abrasion resistance | Accep | Poor | Accep | Accep | NT | Good | Good | Accep |
| Tape transfer resistance | Good | Good | Accep | Accep | NT | Good | Good | Good |

NT indicates not tested; Accep = acceptable .

Dry times for the inks as compared with CE1 ranged from about 0.4 average seconds higher (e.g., in IE8, or about to about 25% higher) to about 1.4 average seconds higher. Surprisingly, it has been found that when employing solvents that are acetone free but do use alcohols as cosolvents, dry times are still suitably low for a range of applications including printing on condensing beverages, for example. In comparison, the dry time for Inventive Example 4 was 2.1 seconds and Inventive Example 6 was 1.5 seconds. When varying the cosolvent alcohol, dry times were better when using ethanol even in large excess to the level chosen for n-propanol. Without being bound to theory, it is assumed that a complex interplay of chemical interaction within the ink and drop spreading contribute to the relative performance. The inks as shown furthermore exhibited reasonably good pasteurization performance and adhesion to a wide latitude of materials as demonstrated by relative abrasion and tape testing. Very good overall results were obtained with IE8, which used a 7.5 to 5 ratio of CAB 551-0.01 to Rezlastic™ 2133. Ink performance was improved by certain surfactants, solvents and resinous components.

### Example 3 Printer Evaluations

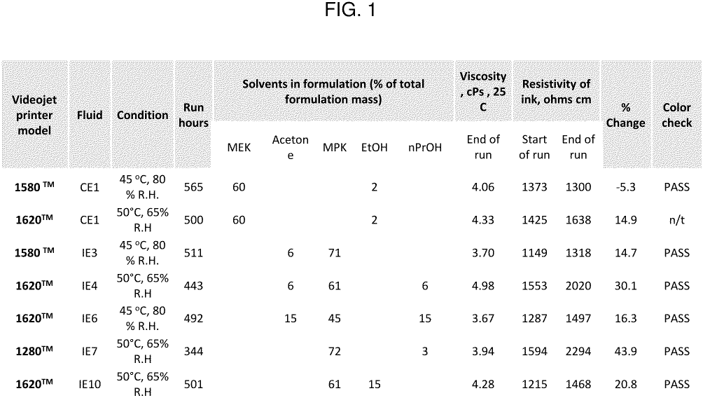

Example inks and CE1 were tested in Videojet CIJ printers each for a few hundred hours at ambient temperatures between 45° C. and 50° C. The printers used a 60-micron nozzle and were operated in idle mode while generating drops within the standard frequency range (60 to 80 kHz drops/sec). During each test, the inks were consistently recirculated in the system through the nozzles without printing so that the inks were effectively exposed to the running system at the prescribed environmental operating temperature and humidity for the entirety of the ‘Run hours’ shown in FIG. 1.

After operating at the specified conditions, the inks were sampled to ascertain their properties including viscosity and resistivity. The resistivity values were compared with initial resistivity values from the printer measured on samples taken near the beginning of the run. Compared with the MEK based CE1, each of the MPK based inks showed greater change. IE8 showed a greater change (21 vs. 15%), but provided an acceptable end resistivity << 2000 and when comparing equivalent operating conditions, was the next most stable after CE1 at the 50° C. condition.

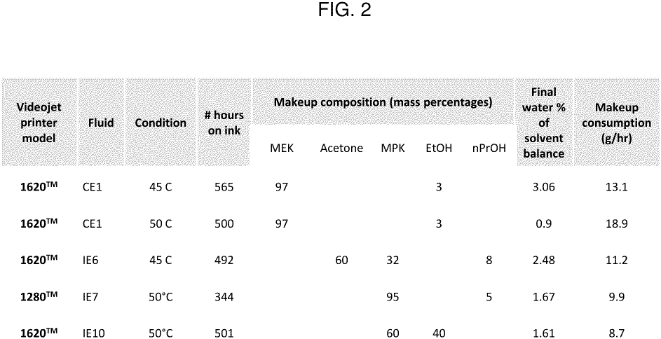

For each of the tests shown in FIG. 1, the ink composition was maintained by the recovery circuit with an appropriate makeup fluid. A subset of the example makeups are provided in FIG. 2 along with the net water content at the end of the run as well as the makeup consumption. Net water was acceptable in all cases, but was better with 15% or lower non-HOK cosolvent and more similar to the comparative controls.

IE5 and IE8 exhibited very low makeup consumption which is of great customer benefit, but IE8 comprised solvents with lower overall safety and odor risk. Surprisingly, the relative makeup consumption observed was not necessarily well predicted by the printed code dry times. For example, the observed makeup use rate in these trials CE1 was more than 50% higher than IE10, while the code drying rate for IE10 was only about 25% higher than the former (2.0 vs. 1.6 seconds). For IE6, which exhibited a dry time of 1.5 seconds (as stated above), only 25% better, the makeup consumption rate was 11.2 g/hr.

### REFERENCES

All references listed below and throughout the specification are hereby incorporated by reference in their entirety.
1. U.S. Pat. Publication No. 2020-0079967
2. U.S. Pat. Publication No. 2020-0010704
3. U.S. Pat. Publication No. 2021-0040337
4. U.S. Pat. No. 6,010,564
5. U.S. Pat. No. 9,083,310
6. U.S. Pat. No. 5,652,286
7. U.S. Pat. No. 5,594,044
8. International Patent Publication No. WO 2008/061765
9. U.S. Pat. Publication No. 2010-0028632

1. A continuous inkjet ink composition comprising:
(a) a primary ketone solvent which contains at least 5 carbon atoms;
(b) at least one secondary solvent with a derived no effect inhalation level greater than 200 mg/m³;
(c) a first cellulose resin;
(d) a second polyurethane resin;
(e) optionally, a third resin; and
(f) a colorant.

2. A continuous inkjet ink composition comprising:
(a) a solvent system consisting essentially of a primary ketone solvent which contains at least 5 carbon atoms and at least one secondary solvent selected from the group consisting of acetone, methanol, ethanol, n-propanol, isopropanol, or a combination thereof;
(b) a first cellulose resin;
(c) a second polyurethane resin;
(d) optionally, a third resin; and
(e) a colorant.

3. The continuous inkjet ink composition of claim 1 wherein the primary ketone solvent is MPK and the secondary solvent is ethanol and wherein the ratio of MPK to ethanol is from about 2.5:1 to about 15:1.

4. The continuous inkjet ink composition of claim 1 wherein the primary ketone solvent comprises at least about 40% to about 80% by weight of the ink composition.

5. The continuous inkjet ink composition of claim 1 wherein the secondary solvent comprises up to about 50% by weight of the ink composition.

6. The continuous inkjet ink composition of claim 1 wherein the secondary solvent comprises about 20% or less by weight of the ink composition.

7. The continuous inkjet ink composition of claim 1 wherein the secondary solvent is selected from the group consisting of ethanol, n-propanol, isopropanol, or a combination thereof.

8. The continuous inkjet ink composition of claim 1 which contains less than 5% by weight of the ink composition of water.

9. The continuous inkjet ink composition of claim 1 wherein the cellulose resin is a cellulose ester resin.

10. The continuous inkjet ink composition of claim 1 wherein the third resin is selected from the group consisting of an acrylic resin, a rosin ester, a terpene phenolic resin, a silicone resin, a tosylamide resin, and a combination thereof.

11. The continuous inkjet ink composition of claim 1, wherein the ratio of polyurethane resin to other resins combined is 1:4 or greater.

12. The continuous inkjet ink composition of claim 1 wherein the colorant is a conductive dye.

13. The continuous inkjet ink composition of claim 12 wherein the ink is substantially free of conductive agent that is not a conductive dye.

14. The continuous inkjet ink composition of claim 1 further comprising at least 100 ppm of a silane-based adhesion promotor.

15. The continuous inkjet ink composition of claim 1 further comprising a surfactant or wetting agent.

16. The continuous inkjet ink composition of claim 1 further comprising a defoamer.

17. The continuous inkjet ink composition of claim 1 which contains total ink solids of about 15% and about 30%.

18. The continuous inkjet ink composition of claim 1 which contains total resin solids of about 8% to about 20%.

19. The continuous inkjet ink composition of claim 1 which has a dry time for printed codes of less than about 5 seconds at 20° C. to 25° C.

20. The continuous inkjet ink composition of claim 1 which has an initial ink resistivity of 1600 ohms cm or lower at 25° C.

21. A continuous inkjet ink composition of claim 1 comprising:
(a) about 60% methyl propyl ketone solvent;
(b) about 15% ethanol;
(c) less than about 2% water;
(d) about 6.5% cellulose ester resin;
(e) about 5% polyurethane resin;
(f) about 9% dye;
(g) about 1.2% silane adhesion promoter; and
(h) about 0.1% surfactant.
